(19) United States
(12) Patent Application Publication
(10) Pub. No.: US 2019/0116871 A1
(43) Pub. Date: Apr. 25, 2019

(54) Method and Device for a Resin Infused Cigarette Rolling Paper

(71) Applicant: Michael Beck, Philadelphia, PA (US)

(72) Inventor: Michael Beck, Philadelphia, PA (US)

(73) Assignee: Michael Beck, Philadelphia, PA (US)

(21) Appl. No.: 16/300,477

(22) PCT Filed: May 9, 2017
(86) PCT No.: PCT/US17/31751

§ 371 Date: Nov. 9, 2018

Related U.S. Application Data
(60) Provisional application No. 62/333,437, filed on May 9, 2016.

(30) Foreign Application Priority Data
May 9, 2017 (US) PCT/US2017/031751

(51) Int. Cl. A24D 1/02

(52) U.S. Cl. CPC A24D 1/022; B41M 1/12; A24D 1/025

(57) ABSTRACT

A cigarette rolling paper and method for manufacture is disclosed which describes a cigarette rolling paper containing an inner paper that has plant oleoresins, essential oils, and or rosins applied to the inner paper through a screen printing process, which in turn is bound to an outer paper. The oleoresins are applied using both an evaporative and silk screen-printing technique. The final rolling paper contains an precise, pre-measured amount of oleoresin and is intended for flavoring and enhancing hand rolled cigarettes, and promoting a slow and even burn.

### CROSS-REFERENCE TO RELATED APPLICATIONS

This application is the US national application of PCT/US2017/031751, filed on 9 May 2017 which claims priority to U.S. Provisional application No. 62/333,437, filed on 9 May 2016, now expired, the disclosures of which are herein incorporated by reference in its entirety.

### BACKGROUND OF THE INVENTION

### 1. Field of the Invention

The present invention relates to cigarette rolling papers and, more particularly, to a resin infusion process that infuses plant oleoresins, essential oils or other resins to the rolling paper used in cigarettes.

### 2. Description of the Prior Art

Popular smoking articles, such as cigarettes, have a substantially cylindrical rod-shaped structure and include a roll or column of smoking material such as shredded tobacco (e.g., in cut filler form) surrounded by a paper wrapper or rolling paper thereby forming a so-called “tobacco rod.”

Numerous references propose various types of cigarettes possessing various types of paper wrapping materials. See, for example, U.S. Pat. No. 1,909,924 to Schweitzer; U.S. Pat. No. 4,489,650 to Weinert; U.S. Pat. No. 3,030,963 to Cohn; U.S. Pat. No. 4,146,040 to Cohn; U.S. Pat. No. 4,489,738 to Simon; U.S. Pat. No. 4,615,345 to Durocher; U.S. Pat. No. 4,607,647 to Dashley; U.S. Pat. No. 5,060,675 to Milford et al.; U.S. Pat. No. 4,924,888 to Perfetti et al.; U.S. Pat. No. 5,143,098 to Rogers et al.; U.S. Pat. No. 4,998,543 to Goodman; U.S. Pat. No. 5,220,930 to Gentry; and U.S. Pat. No. 5,271,419 to Arzonico et al. Some paper wrapping materials are so-called “banded papers” and possess segments defined by the composition, location and properties of the various materials within those wrapping materials. Numerous references contain disclosures suggesting various banded wrapping material configurations. See, for example, U.S. Pat. No. 1,996,002 to Seaman; U.S. Pat. No. 2,013,508 to Seaman; U.S. Pat. No. 4,452,259 to Norman et al.; U.S. Pat. No. 5,417,228 to Baldwin et al.; U.S. Pat. No. 5,878,753 to Peterson et al., U.S. Pat. No. 5,878,754 to Peterson et al.; and U.S. Pat. No. 6,198,537 to Bokelman et al.; U.S. Patent Application Publication No. 2003/0131860 to Ashcraft et al.; and PCT WO 02/37991.

The design of these papers provide the desired burn characteristics and/or other characteristics of such wrapping materials, it has been desirable to improve the characteristics of the wrapping material for cigarettes. These include, for example, measuring the air permeability or porosity of such wrapping papers, as well as the diffusion of gases, such as carbon monoxide

There is a further need to provide a flavoring to enhance the experience of a hand-rolled cigarette which has a slow and even burn and to have a process that can selectively control the amount of flavoring along the longitudinal length of the tobacco rod.

### SUMMARY OF THE INVENTION

The objective of the present invention is to provide a flavored tobacco rolling paper, and method of production for producing a roll or tube of smoking paper which contains an additional flavoring during the smoking process. In one embodiment, the rolling paper contains an insert having plant extracts including, but not limited to, oleoresins, essential oils or rosin applied to one or both sides through an infusion process. In another embodiment, two sheets of paper of equal or substantially similar dimensions are used to allow a natural gum resin to effectively bind the two sheets.

The infusion process is based on a silk screen printing technique whereby a strip or sheet of paper is infused on one or both sides with a pre-measured amount of plant extract or oleoresin. In one embodiment, the present invention considers a preliminary evaporation process with the isopropyl alcohol for binding of the inner strip or optionally when binding full sheets which are not intended to be hand rolled cigarettes. When the process utilizes two sheets, printing can be on one side of one or both sheets. The two sheet process can use either one sheet for both infusion of the resin oil and application of the adhesive with a blank sheet bonded on top or, optionally, one sheet can be used for infusion of the resin oil and the other sheet for application of the adhesive with both sheets bonded together. With any of these selected steps, the inner surface of the outer rolling paper and outer surface of the inner paper are bound together to produce a hand-rolled cigarette or full sheets for cutting into individual sheets, each with enhanced flavoring and having a slow and even burn.

### BRIEF DESCRIPTION OF THE DRAWINGS

FIG. 1 is a drawing of the top view of flavored rolling paper prior to forming a cigarette rod. The inner surface of the outer paper (B) is shown with the insert or inner paper (C) having smaller width and length. A natural gum (A) maintains the tubular shape of the paper when rolled into a smoking form. Optionally, an area (D) having a filter or tip and not the infused insert is shown.

FIG. 2 shows the process for fitting the insert into the rolling paper. The insert or inner paper (C) is screen-printed with a specific amount of plant oleoresins on both sides and then cut to the appropriate size for insertion. The rolling paper (B) is primed with isopropyl alcohol at the designated area to receive the insert (C). The insert is bound to the outer rolling paper by applying C to B and allowing the paper to dry.

FIG. 3 shown is a specific printed design where the pattern of resin oil provides an optimum amount of flavor or aroma along the longitudinal axis of the final tobacco rod. The resin oil pattern is printed on the inner paper which is then positioned and bound to the outer paper within the dimensions of the outer paper.

FIG. 4 represents the series of steps required for producing flavored tobacco rolling paper. Panel A shows the inner surface of the outer paper where the inner surface is screen printed with a light sticky resin along the perimeter to attach to the outer surface of the inner paper where a specific pattern of resin oil is printed. The inner paper having a specific pattern design made from screen printing with resin oil. Panel B shows the inner surface of the outer paper applied to the outer surface of the inner paper with the resin pattern concealed between the outer paper and inner paper. Panel C shows the final flavored rolling paper having the outer and inner papers bound together with the resin pattern on the inner paper.

FIG. 5 is a representation of a large sheet having both inner and outer sheets bound in a fully assembled sheet ready for cutting into individual cigarette-sized sheets. Also shown are two individual cut-outs from the large sheet to be formed into the tubular shape for smoking. Shown also are two individual cigarette sheets cut from the larger sheet.

FIG. 6 shows one embodiment of the present invention where the large sheets are formed by printing the resin oil on one sheet and applying the adhesive on the second sheet, aligning the two sheets and binding together.

FIG. 7 shows another embodiment of the present invention where both the printing of the resin oil and the adhesive are applied to a first sheet and the second sheet is used as a blank sheet which is bound to the first sheet covering the resin oil on the first sheet.

### DESCRIPTION OF THE PREFERRED EMBODIMENTS

The figures and descriptions of the present invention are presented in a simplified format to illustrate elements that are relevant for a clear understanding of the present invention, while eliminating, for purposes of clarity, other elements found in typical rolling paper or the means for producing rolling paper. Those of ordinary skill in the art will recognize that other elements may be desirable and/or required in order to implement the present invention. Because such elements are well known in the art and because they do not facilitate a better understanding of the present invention, a discussion of such elements is not provided herein. It should also to be understood that the drawings included herewith only provide diagrammatic representations of the presently preferred structures of the present invention and that other structures falling within the scope of the present invention may include structures different than those shown in the drawings.

A paper strip containing plant extract or resin oil such as, but not limited to, oleoresins, essential oils and other rosins is used as an insert to a cigarette rolling paper to provide additional flavor or aroma and enhance the smoking experience. Flavoring includes the incorporation of additives that alter the taste, smell or can provide any other desired benefit produced by an infused extract. Flavoring can also include incorporating additives that provide health or therapeutic benefits as the infusion process allows exact amounts of extract to be incorporated into the rolling paper. The inner paper strip is infused by any means known in the art on one or both sides using a plant extract prior to binding to the inner surface of the outer rolling paper. The combined rolling paper is then used to roll tobacco or other smoking material to form a cigarette. The entire cigarette can be bound together using a natural gum or other binding agent to maintain the tubular shape for smoking. The infusion process is able to provide a uniform distribution of an exact amount of resin or adjusted to provide a specific quantity over an exact region or length along the longitudinal length of the tobacco rod.

One embodiment of the present invention considers an improved composition for a cigarette or other tubular smoking product where the paper portion for encasing the tobacco or other targeted smoking material comprises two layers of paper. An inner layer is infused with a plant extract, any appropriate resin, or preferably an oleoresin (referred herein as “resin oil”). The resin oil can be screen-printed on one or both surfaces of the inner paper, preferably on one surface with a printed design on the outer surface and bound to the inner surface of the outer paper using isopropyl alcohol or preferably with a light sticky resin or gum. The combined paper or rolling paper is then cut to the appropriate shape for commercial sale as cigarette rolling paper.

Another embodiment of the present invention relates to the method for manufacturing the flavored rolling papers. This improved process results in an inexpensive and rapid means to produces sufficient commercial quantities of flavored rolling papers in the commercial manufacture of tubular cigarettes. The rolling paper of the present invention is made by infusing an inner paper which is bound by an adhesive to an outer layer of paper through their outer and inner surfaces, respectively.

The inner paper is infused with a resin oil having the desired flavor, aroma, or any other additional effect on the smoking experience. The infusion process incorporates, in part, an evaporative and silk screen printing technique that results in the resin oil being infused in and on to the inner paper.

In one embodiment, a pre-measured amount of resin oil is applied to both sides of the inner paper to form an evenly distributed coating which is then bound using a known adhesive to the inner surface of the outer paper. The silk screen process allows for an even distribution and requires a significantly high temperature to ensure that the resin remains at the proper viscosity in order to permeate the screen. This temperature is dependent upon the particular plant resin and requires optimizing the temperature for the resin type. Some resins are in a semisolid to solid state at room temperature. Accordingly, the temperature during the process should be high enough to have a viscosity that allows proper flow, but not to exceed a temperature that affects the final flavor of the resin. Most resin oils print at approximately 125° F., but better efficiency is obtained at higher temperatures. Typical temperatures are approximately 95° F., but all temperatures are considered that meet the functional criteria described herein. A typical range of temperatures for the process is approximately 90° F. to approximately 140° F. preferred range is between 90° F. and 103° F.

The infused inner paper is then bound to the inner surface of the outer paper. In one embodiment, binding to the rolling paper is accomplished by exposing the inner surface of the outer paper to isopropyl alcohol at the designated area. The insert is then bound to the outer rolling paper by allowing the isopropyl alcohol to evaporate and the paper to dry leaving the insert in place.

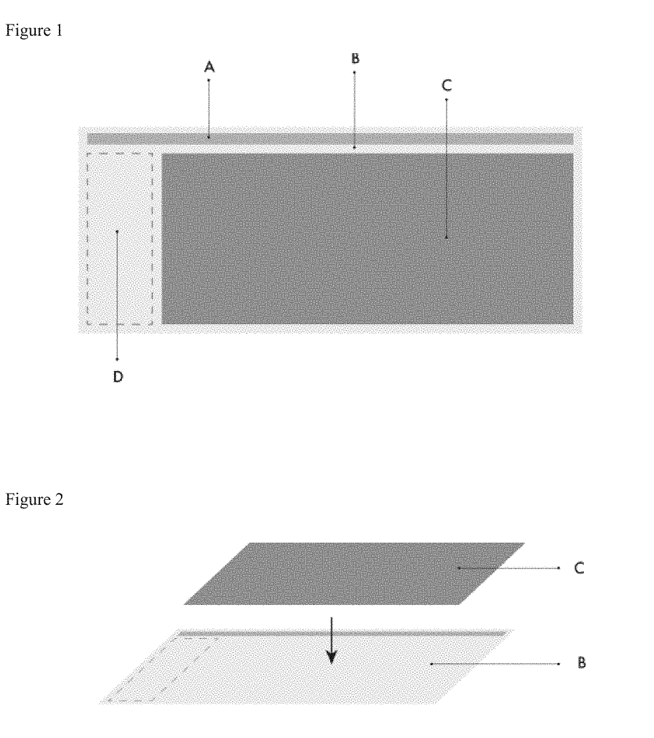

One embodiment of the present invention is depicted in FIG. 1, a schematic of a single of rolling paper for a single cigarette is shown with a top view of the rolling paper having an outer paper (B) with an insert or inner paper (C) positioned on the inner surface of the outer paper. The insert, C, is fixed onto the inner surface of the outer paper (B) with the insert (C) situated within the inner surface after binding. A natural gum (A) is added along the outer edge of the inner surface of (B) and maintains the tubular shape of the paper when rolled with tobacco and in a smoking form. Optionally, an area (D) having a filter or tip and not the infused insert is also shown.

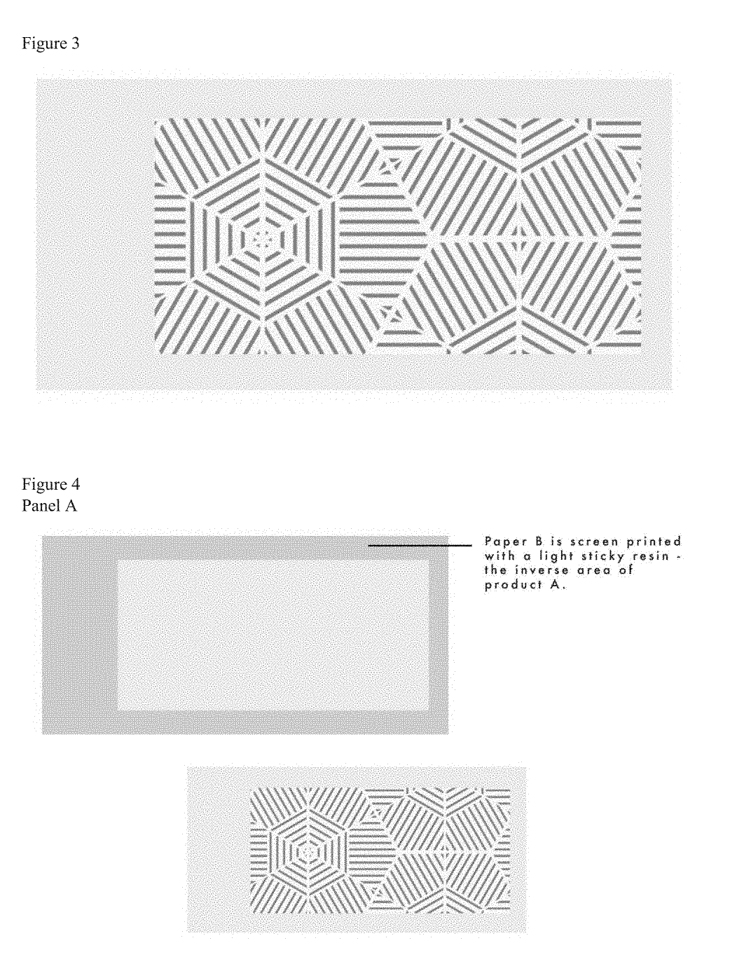

Another embodiment is shown in FIG. 2 for the assembly of the rolling paper described in the present invention. Shown is a schematic view of the steps required for a final binding of the outer surface of the inner paper (C) onto the inner surface of the outer paper, B. The insert (C) is screen-printed with a specific amount of plant oleoresins on both sides and then cut to the appropriate size for insertion. The inner surface of the outer paper (B) is primed with isopropyl alcohol at the designated area to receive the insert (C). The insert is bound to the outer paper by applying C to B and allowing the paper to dry.

In yet another embodiment, a flavored rolling paper is formed having the resin oil infused as a printed design on the outer surface of the inner paper which is bound to the inner surface of the outer paper by a light sticky resin. The printed design has a specific pattern of resin oil generated on the outer surface of the inner paper to provide a specific amount of flavor or aroma at a precise position along the rolling paper when formed into a final tubular shape for smoking. While any pattern is consider in the present invention, each pattern determines the specific amount of resin oil released along the longitudinal axis of the rolling paper when ignited during use.

As shown in FIG. 3, one pattern is optimized for the maximum release of flavor continuously along the longitudinal axis. This pattern is formed by printing the resin oil onto the outer surface of the inner paper using a known, precise amount of resin oil. In this manner, a uniform, consistent release of the resin oil (and consequently the flavor) is obtained. It should be noted that this process allows for the use of resin oils classified as controlled substances and highly regulated to be precisely incorporated in known amounts for use in any cigarette or other smoking product. Accordingly, the process of manufacture and composition of the present invention has significant benefits in the treatment of disease and in medical research.

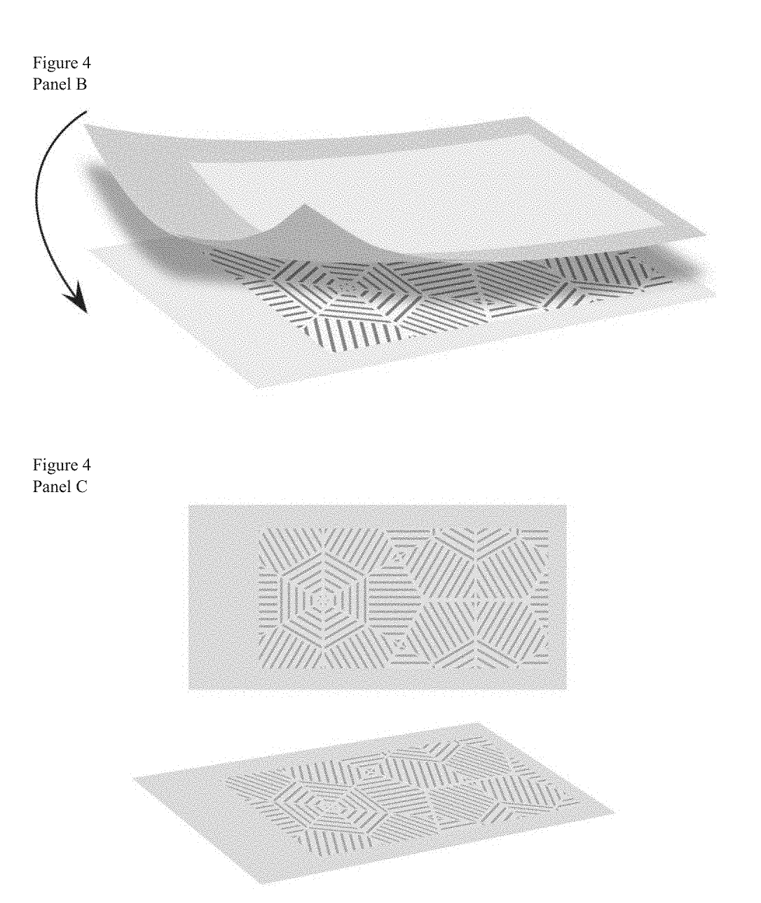

As shown in FIG. 4, there are a series of steps required for producing a flavored tobacco rolling paper. Panel A depicts the two papers prior to binding where the inner surface of the outer paper is screen printed with a light sticky resin along the perimeter for attachment to the inner paper. The outer surface of the inner paper has a specific pattern screen printed with the flavored resin oil. The pattern is chosen to provide a specific effect when using the final product. With the pattern shown, an optimum distribution of flavor is obtained along the entire longitudinal axis of the rolling paper when formed into a cigarette. Panel B shows the outer surface of the inner paper applied to the inner surface of the outer paper with the resin pattern concealed between the outer paper and inner paper. The outer paper and inner paper are bound together with the sticky resin. Panel D shows the final flavored rolling paper with the resin pattern.

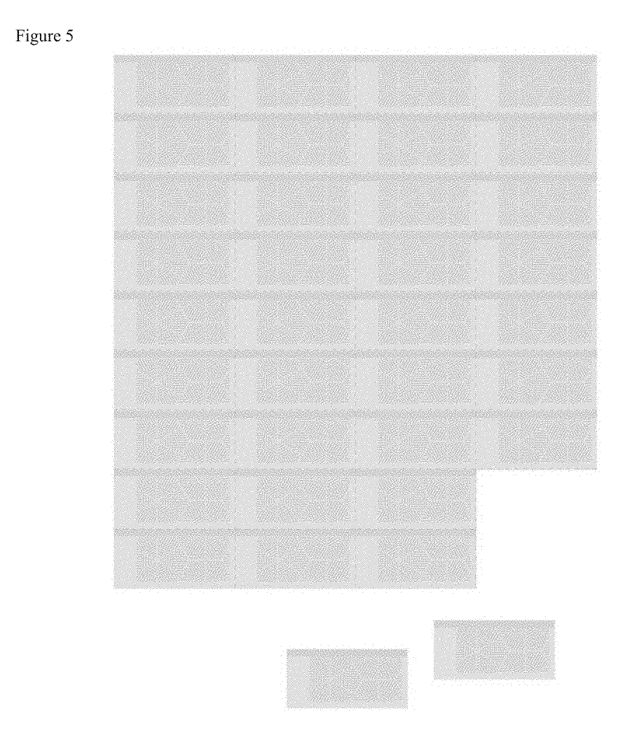

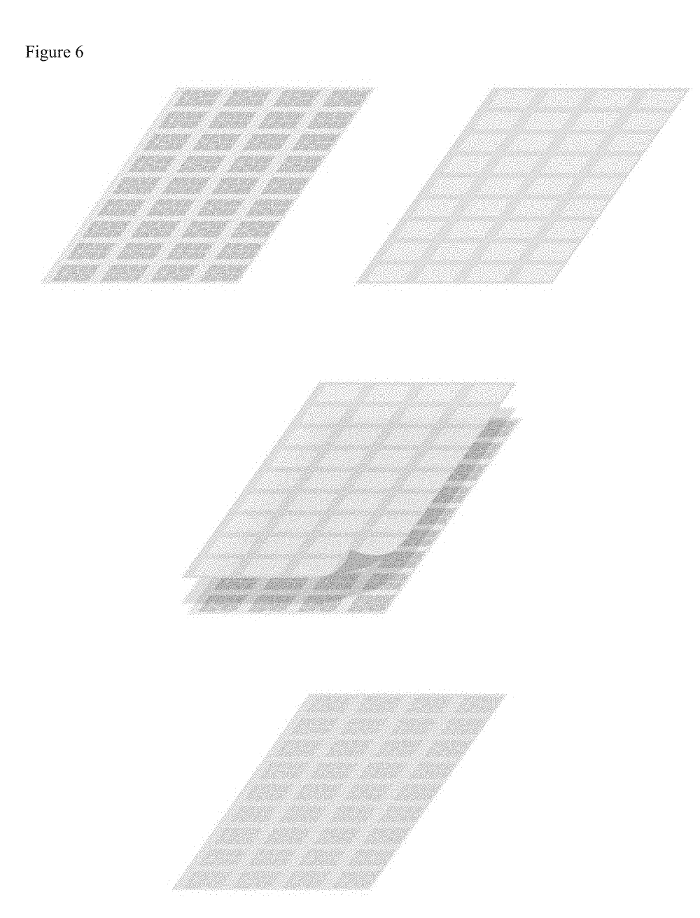

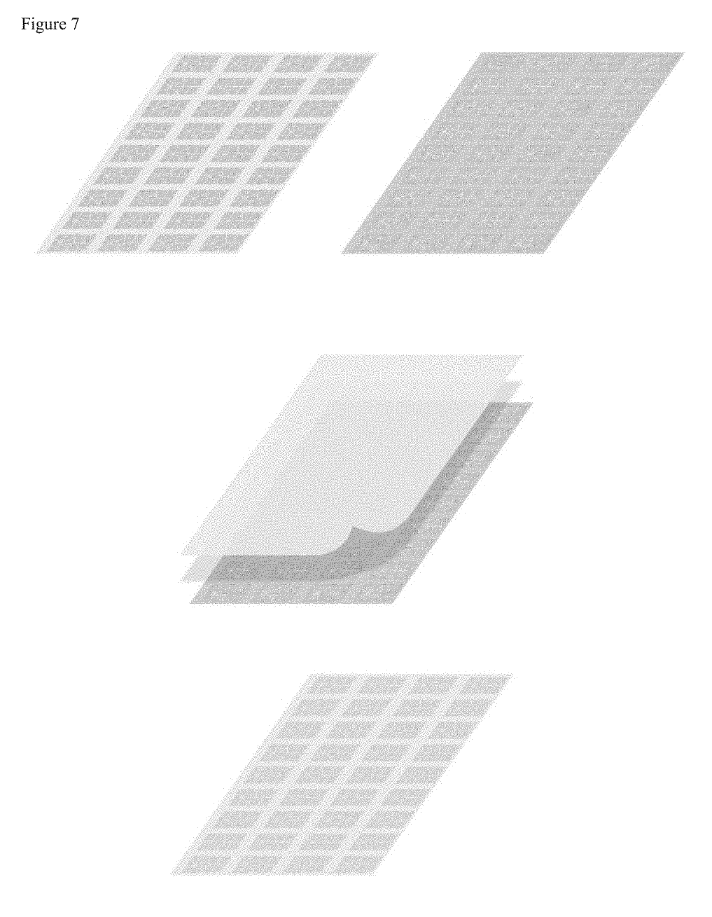

The process is especially applicable to commercial production using this screen printing technique to generate multiple sets of patterns on large sheets of paper. The paper is then bound to another large sheet and smaller individual sheets of cigarette papers are precisely cut from the two bound paper sheets for uniform production and strict quality control of the final tubular cigarette. FIG. 5 represents a fully assembled sheet with the inner sheet bound to the outer sheet. Shown also are two individual cigarette sheets cut from the larger sheet. FIG. 6 depicts one option for printing the resin oil and binding the two sheets. Here the resin oil is printed onto one sheet and the adhesive applied to the second prior to binding the two sheets together. In FIG. 7, both infusion of the resin oil and the application of the adhesive is on one large sheet. A blank sheet is then applied on top forming a seal, binding the two sheets together.

Those of ordinary skill in the art will recognize that various modification and variation may be made to the embodiments described above without departing from the spirit and scope of the present invention.

I claim:

1. A flavored rolling paper for a cigarette comprising:
a. an outer paper;
b. an inner paper having an outer surface bound to an inner surface of the outer paper; and
c. a resin oil wherein the resin oil is infused into the inner paper to provide a desired flavor.

2. The rolling paper of claim 1 where the outer paper contains a binding material for adhering to the inner paper.

3. The rolling paper of claim 2 where adhering is by priming an area on the inner surface of the outer paper with isopropyl alcohol and evaporated when layered onto the inner paper.

4. The rolling paper of claim 2 where the binding material is a light sticky resin or gum.

5. The rolling paper of claim 2 where the binding material is a light sticky resin.

6. The rolling paper of claim 1 where the inner paper is infused through a screen printing process.

7. The rolling paper of claim 1 where the inner paper is infused on both inner and outer surfaces.

8. The rolling paper of claim 1 where the inner paper is infused only on the outer surface.

9. The rolling paper of claim 8 where the inner paper is infused on the inner paper to form a printed pattern.

10. The rolling paper of claim 1 where the resin oil is selected from a group consisting of plant extracts, oleoresins, essential oils, and rosins.

11. The rolling paper of claim 1 where the plant extract is oleoresin.

12. The rolling paper of claim 1 further having natural gum along the outer edge of the inner surface of the outer paper to maintain a tubular shape of the cigarette.

13. The rolling paper of claim 1 further having a filter or tip on one end.

14. A process for manufacturing a flavored rolling paper comprising:
a. obtaining a first sheet and second sheet of cigarette rolling paper wherein the first sheet has a width and length capable of rolling a cigarette and the second sheet has a width and length less than the first sheet;
b. infusing a resin oil having a specific flavor on one surface of the second sheet; and
c. binding the infused surface of the second sheet to one surface of the first sheet forming a flavored rolling paper.

15. The process of claim 14 wherein infusing is by screen printing.

16. The process of claim 15 where the screen printing is at a temperature to allow even distribution and flow for the resin oil.

17. The process of claim 16 of approximately 95° F.

18. The process of claim 15 where the resin oil forms a pattern on the surface of the paper.

19. The process of claim 14 wherein the resin oil is oleoresin.

20. A method for making a tobacco rod comprising:
a. placing the rolling paper from claim 1 on a flat surface with the inner paper surface on top;
b. adding a sufficient amount of smoking material along a longitudinal line of the rolling paper;
c. rolling the rolling paper to form a tobacco rod; and
d. sealing the tobacco rod with gum
wherein the tobacco rod is of a suitable diameter and length to be smoked as a cigarette.
